(19) United States
(12) Patent Application Publication
(10) Pub. No.: US 2012/0330774 A1
(43) Pub. Date: Dec. 27, 2012

(54) METHOD AND APPARATUS FOR AGGREGATING, MATCHING OR TRANSACTING USERS' INTERESTS

(75) Inventors: Alon Sadot, Hadera (IL); Shabtay Gertzek, Nahariya (IL); Avri Sela, Kfar Vradim (IL)

(73) Assignee: APACOS LTD., Hadera (IL)

(21) Appl. No.: 13/519,329

(22) PCT Filed: Jan. 11, 2011
(86) PCT No.: PCT/IL11/00027

§ 371 Date: Jun. 27, 2012

Related U.S. Application Data
(60) Provisional application No. 61/294,472, filed on Jan. 12, 2010.

(51) Int. Cl. G06Q 30/08; G06Q 30/00

(52) U.S. Cl. 705/26.3; 705/27.1; 705/26.1

(57) ABSTRACT

A method and apparatus for aggregating, matching or transacting users' interests, the method comprising: receiving from a user a request to purchase a good; defining a deal, the deal in compliance with the request; notifying a vendor about the deal; and receiving a bid from the vendor, the bid based on the deal. Optionally the method further receives the bid from the vendor, and notifies the buyer about the bid. Optionally, the method further receives an order from the buyer and sends the order to the vendor.

### TECHNICAL FIELD

The present disclosure relates to a system and method for providing internet applications in general, and to trade applications in particular.

### BACKGROUND

The Internet has provided many opportunities for users to obtain information, view content of interest, interact with each other, or the like, and particularly participate in trading. However, many applications aimed at enabling such goals have yielded disappointing results. Examples of applications which have failed to provide expected success include reverse auctions, in which users are gathered to purchase a product as a purchasing group, micropayments, or the like.

On the other hand, applications which have succeeded on the Internet sometimes involve providing a user centric experience, i.e., they revolve around the user. Examples include social networking applications, which center around the experience and interests of the user, and travel purchasing websites, which are focused on fulfilling a particular set of interests and desires of the user regarding travel arrangements.

Yet other applications have had partial success, for example, mass sending of e-mails. Frequently such bulk emails are considered to be spam and are blocked by special software; yet the email continues to be sent because many users do receive the mail, and purchase the products offered through the spam e-mail.

There is thus a need in the art of providing an overall user-based experience through the Internet. In particular, an apparatus and method are required for enabling a user to purchase goods such as information, products or services under improved terms, which a vendor may be able to suggest only if large quantities are to be purchased.

### BRIEF SUMMARY OF THE DISCLOSURE

One exemplary embodiment of the disclosed subject matter is a computer-implemented method performed by a computing platform, comprising: receiving from a user a request to purchase a good; defining a deal, the deal complying with the request and with at least one second request stored on a storage device associated with the computing platform; notifying a vendor about the deal; and receiving a bid from the vendor to provide the good, the bid based on the deal. The method can further comprise notifying the user about the bid. The method can further comprise receiving from the user an order based on the bid. Within the method, the request optionally comprises identification of a good type and one or more attributes, the attributes related to one or more properties selected from the group consisting of: the good and supplying the good, and said defining the deal optionally comprises creating an extension of the request, the extension being less restrictive than the request, and defining the deal is based on the extension. Within the method, said creating the extension optionally comprises: creating an extension set comprising one or more extensions to the request, wherein each of the extensions is less restrictive than the request; determining a score for each extension of the extensions set; based on the score, selecting the extension out of the extension set. Within the method, said creating the extension set optionally comprises: for a portion of the one or more attributes, determining a less restrictive one or more attributes, the less restrictive one or more attributes being within a likelihood measurement of the portion of the attributes. Within the method, said determining the score for each extension optionally comprises determining a number of non-met requests that are in compliance with the extension to obtain a requests number. Within the method, said determining the score for each extension optionally comprises determining a number of vendors that can supply the extension to obtain a vendor number. Within the method, said determining the score for each extension optionally comprises determining a likelihood factor between the request and the extension. Within the method, said determining a score for an extension optionally comprises: determining a request number as a number of non-met requests that are in compliance with the extension to obtain; determining a vendor number as a number of vendors that can supply the extension to obtain; determining a likelihood factor between the request and the extension; and combining the requests number, the vendor number, the likelihood factor and information related to historical requests.

Another exemplary embodiment of the disclosed subject matter is an apparatus adapted to be execute by one or more computing platforms, comprising: a query interface for interfacing with a user computer, and with a business computer, the query interface comprising: a buyer interface comprising a first receiving component for receiving a request from a buyer; and a vendor interface comprising a notification component for notifying a vendor about a deal; a central analysis engine comprising: a deal definition component for defining a deal, the deal complying with the request and with one or more second requests stored on a storage device associated with the one or more computing platforms; a vendor rule assessment engine for determining a vendor to be notified with the deal; and a database for storing the request and the deal. Within the apparatus, the buyer interface optionally further comprises a component for notifying the buyer about a bid suggested by the vendor. Within the apparatus: the buyer interface optionally further comprises a component for receiving an order from the buyer, and wherein the vendor interface further comprises a component for notifying the vendor about the order. Within the apparatus, the request optionally comprises identification of a good category, and one or more attributes, the attributes relating to one or more properties selected from the group consisting of: the good and supplying the good, and wherein defining the deal definition component comprises an extension creation component for creating one or more extensions of the request, each extension being less restrictive than the request. The apparatus can further comprise: an extension set creation component for creating an extension set comprising the extensions; and a score determination component for determining a score for each extension of the extension set. Within the apparatus, creating each extension of the extension set optionally comprises: for a portion of the one or more attributes, determining a less restrictive one or more attributes, the less restrictive one or more attributes being within a likelihood measurement of the portion of the one or more attributes. Within the apparatus, the score determination component optionally comprises: a non-met requests number determination component for determining the number of non-met requests which comply with the extension; a vendor number determination component for determining the number of vendors that can supply the extension to obtain a second factor; a likelihood determination component for determining a likelihood factor between the request and the extension to obtain a third factor; and a combination component for combining the of non-met requests, the number of vendors and the likelihood factor. Within the apparatus, the query interface optionally further comprises a component for receiving product information from vendors, the information necessary for policy processing.

Yet another exemplary embodiment of the disclosed subject matter is a method for providing a aggregated purchasing apparatus comprising: providing a buyer engine; providing a vendor engine and a policy definition engine; and providing a deal definition component for defining a deal based on requests, wherein the buyer engine, vendor engine, policy definition engine or deal definition component is embedded on one or more computer storage mediums.

Yet another exemplary embodiment of the disclosed subject matter is a computer program product comprising: a non-transitory computer readable medium; a first program instruction for receiving from a user a request to purchase a good; a second program instruction for defining a deal, the deal complying with the request and with one or more second requests stored on a storage device associated with the computing platform; a third program instruction for notifying a vendor about the deal; and a fourth program instruction for receiving a bid from the vendor to provide the good, the bid based on the deal, wherein said first, second, third and fourth program instructions are stored on said non-transitory computer readable medium.

### DESCRIPTION OF THE DRAWINGS

The present subject matter will be understood and appreciated more fully from the following detailed description taken in conjunction with the drawings. In the drawings corresponding or like numerals or identifiers indicate corresponding or like components. Unless indicated otherwise, the drawings provide exemplary embodiments or aspects of the disclosure and do not limit the scope of the disclosure. In particular, the drawings are not to scale. In the drawings:

FIGS. 1A and 1B show exemplary illustrative systems and environments for aggregating interests, in accordance with some exemplary embodiments of the disclosure;

FIG. 2 is a flowchart of the main steps in a method for aggregated purchasing, in accordance with some exemplary embodiments of the disclosure;

FIG. 3 is a flowchart of the main steps in a method for deal definition, in accordance with some exemplary embodiments of the disclosure;

FIG. 4A is a flowchart of the main steps in a method for creating an extension set, in accordance with some exemplary embodiments of the disclosure;

FIG. 4B is a flowchart of steps in a method for creating an scoring an extension, in accordance with some exemplary embodiments of the disclosure;

FIG. 5 is a block diagram of the main components executed by the central platform, in accordance with some exemplary embodiments of the disclosure;

FIG. 6 is a flowchart of the main steps in a method for providing an apparatus for aggregated purchasing, in accordance with some exemplary embodiments of the disclosure;

FIG. 7 shows a flowchart of an exemplary, illustrative method for an internal economy for the system, in accordance with some exemplary embodiments of the disclosure; and

FIG. 8 relates to a method for detecting, analyzing and preserving user knowledge or user intellectual property (IF) in accordance with some exemplary embodiments of the disclosure.

### DETAILED DESCRIPTION

The present invention, in at least some embodiments, provides a system and method for a user centric experience through a computer network such as the Internet. The system and method preferably provide a user with an environment in which the user can communicate with other users in order to aggregate their individual interests for everyone's benefit.

In some exemplary embodiments, the users’ interests are expressed as requests for purchasing goods, and the requests are aggregated in order to receive better terms form vendors.

The user can be an entity such as a person or an organization wishing to purchase a good, such as information, a product, a service or the like. Another type of users comprise an entity such as a person or company who can supply the good, such as an owner or supplier, a service provider, or the like wishing to provide their goods to possible buyers, preferably under terms which are as good as possible. For clarity and unless specifically noted otherwise, when the description below refers to a “user”, the meaning is a buyer or a consumer, i.e., a person or an organization wishing to purchase or consume goods such as products, information, or services, and a “business” generally refers to a vendor, wishing to sell, license or otherwise provide such goods.

In the disclosed exemplary implementation, the apparatus and method comprise receiving a request from a buyer indicating a good such as a product or service he or she is interested in, and optionally a number of attributes related to the good, or to the purchasing terms, such as a deadline by which he wishes to complete the deal. The apparatus and method aim to define a deal and create buyer groups by aggregating different buyer requests, so that the deal becomes more attractive to vendors. However, in some exemplary embodiments, the group members may not be aware that a group is created, or who other members of the group are. User requests are aggregated based on request attributes as issued by the users. For example a buyer's request to buy a white refrigerator wherein the buyer does not care whether the refrigerator is a top-freezer, bottom-freezer or side-by-side, can be combined into a deal together with a request for buying a refrigerator with a top freezer wherein the buyer does not care about the color.

Some of the attributes provided by the buyer may represent hard constraints which the user does not wish to compromise on, such as power supply for an electrical appliance, maximal size of a piece of furniture, or the like, while others may represent soft constraints which are merely user preferences which the user may compromise on. In some exemplary embodiments, the user may indicate which of the constraints are hard and which are soft. In some exemplary embodiments, an automatic determination may be performed, such as based on previous purchases, knowledge of consumption, or the like, so as to determine which of the constraints may be deemed as a hard constraint and which may be deemed as a soft constraint.

Once a deal is defined, it is forwarded to one or more vendors who are known (or are likely) to be able to provide goods of the kind the deal relates to, and possibly complying with other limitations. Each vendor may determine whether and at what terms he wishes to comply with the deal, and if so the vendor may suggest a bid associated with a deadline. The terms may relate to the goods type, the attributes, the potential quantities of the items to be traded, or the like.

In some embodiments, the bid is returned to the system, which in turn offers it to the buyers. Each buyer can place an order related to one or more bids, and once the bid deadline expires, the purchase takes effect. Alternatively, the vendor can send the bid directly to the buyers who can then place orders directly with the vendor

Thus, although the buyers' interests were aggregated by the system, each buyer makes an individual purchase.

If the bid does not satisfy the user's request due to unmet hard constraints, the bid may or may not be notified to the user.

The method and apparatus are thus user-centric, as they enable the initiation of an aggregated purchase by a user wishing to purchase a good. This provides some symmetry between buyers and vendors, since in other systems the aggregated trade is initiated by a vendor that wants to sell a particular product or by a mediating system. Within the current disclosure it is the user's activity that invokes the process which involves devising a deal which may cater to the needs of additional buyers, receiving bids from vendors and leading to one or more actual orders.

In some embodiments, the system uses a combined “push/pull” method in which user interests are combined with analysis of the information, goods and/or services available from vendors, in order to be able to suggest one or more categories or types of information, goods and/or services.

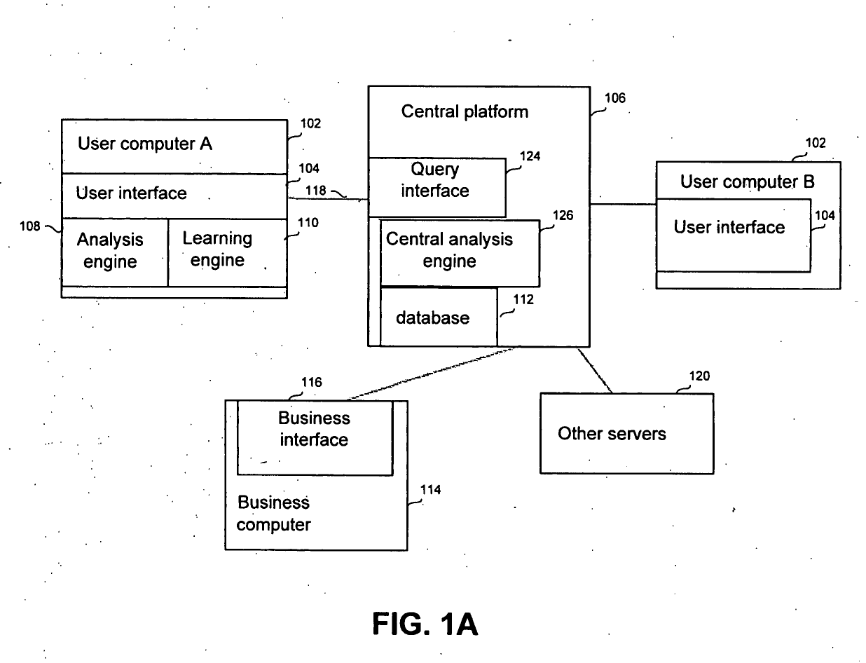

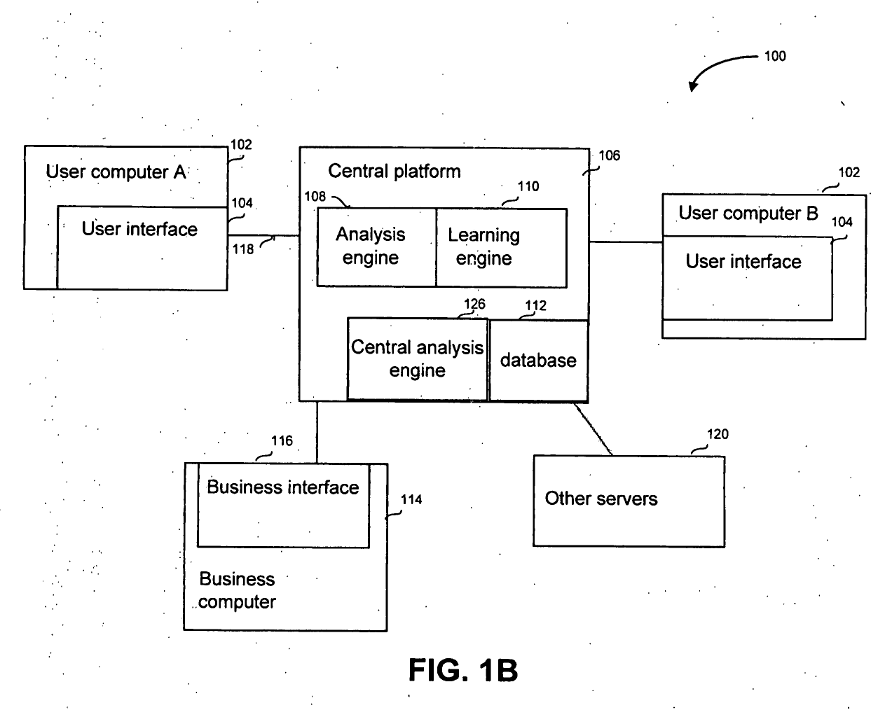

FIGS. 1A and 1B show two exemplary illustrative systems according to some embodiments of the present disclosure.

In FIG. 1A, analysis and learning functions are preferably performed by the user computer interacting with a central platform, while in FIG. 1B, the analysis and learning functions are preferably handled by the central platform.

Referring now to FIG. 1A, showing a system 100. System 100 comprises two exemplary user computers A and B 102 for operation by users (not shown) through a user interface 104. The system additionally comprises central platform 106, and exemplary business computer 114 operated by a vendor.

Each computing platform comprises a memory, a central processing unit (CPU), communication devices, and optionally one or more storage devices. Each storage device may be a persistent storage device, such as a disk, or a volatile storage device such as a memory device. It will be appreciated that in some embodiments the components of each computer or platform, such as user interface 104, analysis engine 108, learning engine 110, business interface 116, query interface 124, and central analysis engine 126 are inter-related sets of computer instructions adapted to be executed by the computer and arranged in any form such as executables, dynamic link libraries, static libraries, packages, functions, methods, scripts or the like. The computer instructions can be written in any programming or scripting language, such as C, C#, C++, Java, or others, and under any development environment, such as J2EE, .NET, or the like. Alternatively, the components can be implemented as one or more DSP chips, an ASIC device storing the commands and data necessary to execute the methods of the present invention, or the like [[I passed this to the AI area]].

At least central platform 106 is associated with a storage device for storing user requests, vendor details, goods details and other information. Such storage device may be a magnetic device such as a tape or a hard disk; an optical device such as a DVD, a CD, or a laser disk; a semiconductor storage device such as flash device, a memory stick, or the like.

User interface 104 enables the buyer to search for goods, enter user related information or requests for information, goods or services, and to generally interact with a central platform 106 through a computer network 118, which may be any communication channel, such as the Internet, intranet, local area network (LAN), wide area network (WAN) or any other communication channel.

User interface 104, as well as business interface 116 comprise graphic user interface components for displaying information to the user and collecting information from the user, the user being a buyer or a vendor. User interface 104 and business interface 116 provide connections to other parts of the system, such as analysis engine 108 or other components of central platform 106. The interfaces may be text base, such as, command line “interfaces,” or Application Programming Interface (API) for entering information by other automated systems.

System 100 preferably features a plurality of user computers 102, two of which are shown, user computer A and B 102, for the purpose of illustration only and without any intention of being limiting in any way. User computers A and B 102 show slightly different configuration, again for the purpose of description and without wishing to be limited in any way. Central platform 106 preferably supports interactions between users through user computers 102 as shown, including supporting the functions of communication channel 118 for system 100. In some embodiments, the user data is preferably maintained on user computer 102 as shown, for privacy reasons. User interface 104 optionally features a learning engine 110 for learning about the preferences of the user, including the types of information, goods and services that are of interest to the user. Learning engine 110 preferably reviews all or a portion of all user interactions with user computer 102, including but not limited to offline interactions between the user and user computer 102, i.e., while user computer 102 is not in communication with computer network 118, and on-line i.e., while user computer 102 is in communication with computer network 118. These interactions may optionally include interactions with any type of software executed by user computer 102, interactions with external websites, and interactions with external computers.

Additionally, such interactions optionally include direct questioning of the user by user interface 104; the answers to such direct questions are preferably provided to learning engine 110. The user is preferably able to set permissions and to control the dissemination of data obtained by learning engine 110. For example, the user can control all different folders, files, data points etc. according to who can view them, when they can be viewed, that only those who live locally can view information, or the like. Such determination of permissions may be performed through user interface 104.

User computer 102 optionally executes an analysis engine. 108 for analyzing information associated with the user such as interactions of the user through user interface 104. Analysis engine 108 preferably communicates with learning engine 110 to receive information about the preferences of the user, to support communication with one or more external entities, preferably through central platform 106. Learning engine 110 preferably enables central platform 106 to push information to the user through user interface 104, such as proposed goods. The push mechanism may optionally be automatic or may be implemented as “invited push” in which the user gives approval to the push through user interface 104. The user may also request information through user interface 104 for pull interactions. Such push and pull interactions are non-limiting examples of two-way communication according to the present disclosure.

In some exemplary embodiments, central platform 106 receives requests from users who are potential buyers, creates a deal aggregating different user requests, evaluates which vendors should be approached with the deal, receives bids from the interested businesses, notifies the buyers about the bid, receives orders from the buyers and passes the orders to the vendors. If some good is provided, the central platform 106 may be involved in the financial transaction.

Central platform 106 may also comprise a database 112, optionally for storing information from learning engine 110, additionally or alternatively and preferably for only storing information regarding interactions between the various components of system 100, information related to vendors such as vendor profiles, information related to goods or the like. Central platform 106 is preferably in communication with one or more business computers such as business computer 114, through a business computer interface 116. Using business computer interface 116, the business having control over business computer 114 is able to communicate with central platform 106.

Central platform 106 is then able to select from the provided, goods for proposing to users through user interface 104. In some exemplary embodiments, for physical goods only a relevant proposal can be pushed to a user, while for all types of information, goods or services, a proposal can be pushed.

For example, a proposal may optionally be provided for the purchase of a physical good such as a television, which may contain detailed information about the good, such as manufacturer's name, brand, model, functional specifications, features and so forth. The proposal preferably enables the user to identify the exact good being offered.

However, a proposal may also be provided that describes information, a service, or any other non-physical good that may be purchased, such as software based product. In this case, too, the proposal may contain detailed information about the item to be potentially purchased, such as the provider's name, brand, specifications, features and so forth. The proposal therefore preferably enables the user to identify the exact goods being offered, and any conditions for the provision of the information, such as the payment terms.

Learning engine 110 may optionally determine whether the user would automatically accept these conditions (for example, in the case of a subscription) or whether such conditions must be provided to the user, for the user to determine whether he or she is willing to agree. Learning engine 110 may also analyze the interactions of user computer 102 with one or more external servers 120, such as web server or other computer server. The user may also choose the extent to which learning engine 110 provides this information about external interactions to central platform 106.

Central platform 106 preferably comprises a query interface 124, for receiving information or requests from user interface 104, business interface 116, or other entities.

Optionally, central platform 106 may request a proposal for goods from the business through business interface 116, for example for a reverse auction.

Analysis engine 108 preferably analyzes the proposals received from business interface 116 and also optionally business or other proposals through user interface 104, to determine which proposals could be of interest to the buyer, according to parameters determined by learning engine 110.

Analysis engine 108 selects such goods, optionally and more preferably according to both explicit information provided by the buyer through user interface 104 and also according to implicit information derived from interactions of the user through user interface 104. In addition, user computer 102 preferably features a database (not shown) for storing information related to that user. This implementation enables user's data to be maintained in a private state on user computer 102.

Learning engine 110 may also optionally detect user interests that are under development or not yet fully expressed, for example as potential user interests. Information determined about the user's preferences may optionally be sent to central analysis engine 126, for use in selecting one or more proposals for the user. In any cases, data collection or learning about the user is preferably maintained as the user property for privacy control. The user may also optionally choose to set different levels of permissions for different interactions.

FIG. 1B shows another implementation of system 100, in which analysis engine 108 and learning engine 110 are installed on central platform 106. Optionally and preferably, each user is able to select whether the components are installed on user computer 102 or on central platform 106, or a combination thereof. If central platform 106 is involved, optionally it is used for supporting the activities of the respective analysis engine 108 and learning engine 110 on user computer 102, for example to provide additional information or analysis capabilities for these activities. In some embodiments, system 100 may be implemented in a peer-to-peer manner without central platform 106.

For either of FIGS. 1A or 1B, Teaming engine 110 may optionally be implemented as a neural network, use genetic algorithms, rule-based engines, machine learning, or any other type of suitable artificial intelligence (AI) method. Furthermore, learning engine 110 may also be able to detect, monitor and analyze subjective interactions of the user with the user computer 102, more preferably through user interface 104. Such subjective interactions may also optionally be detected through interactions between user computer 102 and one or more other servers 120, external websites, or remote computers; interest in viewing information and other types of content such as television content for example, and other aspects. These interactions are preferably also provided to central platform 106. Optionally such interactions are weighted, preferably also including a user rating of each transaction and interaction where available. Business computer 114 may also optionally feature a learning engine and analysis engine. For either of the embodiments shown in FIGS. 1A and 1B, optionally all interactions with external entities, such as business computer 114, other user computers 102, or external servers 120 may optionally be performed through central platform 106. Such interactions may optionally include but are not limited to web browsing, email and the like.

In some exemplary embodiments, interactions, not performed through central platform 106 may also be monitored by a monitoring agent (not shown), installed on a node such as user computer 102 or business computer 114, sniffing network interactions on a communication channel being used such as 118, or the like.

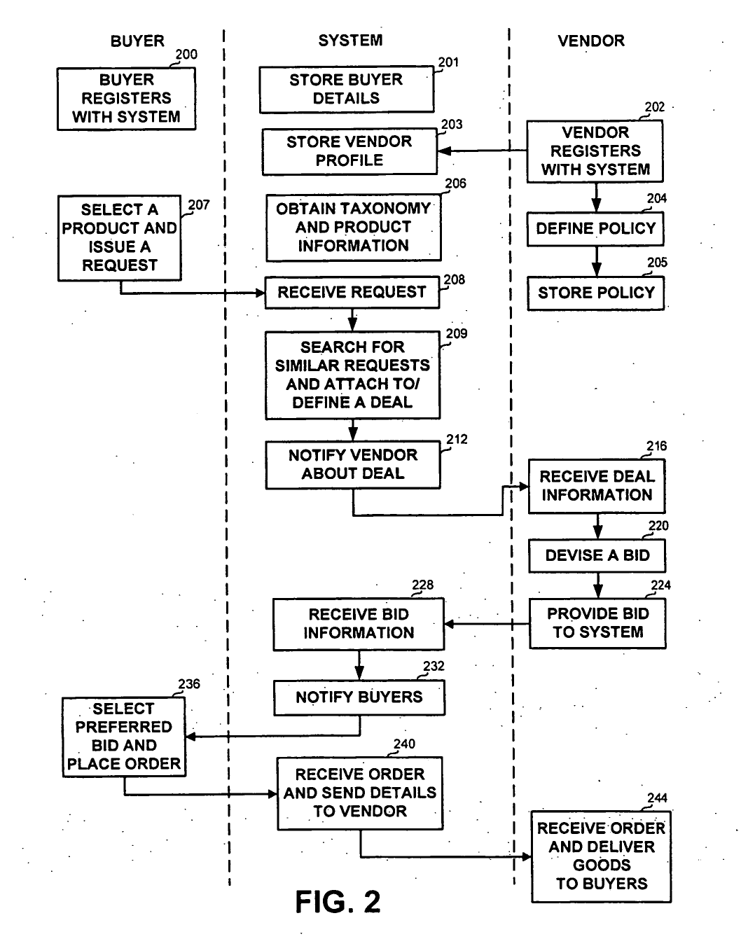

Referring now to FIG. 2, showing a schematic flowchart, of steps in a method for providing aggregated purchasing, in accordance with the description.

In order to fully understand and appreciate the steps of the flowchart of FIG. 2 a number of concepts are explained below.

Taxonomy is a hierarchical classification structure based on generalization-specialization relationships. In the context of the current disclosure, taxonomy relates to a hierarchical organization of goods which may include information, products, services, or other purchasable goods. In such inheritance relationship, each subtype by definition has the same attributes as its super-type, plus one or more additional properties. For example: a car is a subtype of a vehicle, so any car is also a vehicle and has all the attributes of vehicle, but not every vehicle is a car. The goods taxonomy may be implemented in a tree structure of goods classifications. Nodes within the tree that do not have any sub-categories are called “leafs”, and represent concrete goods types, such as “LCD television set”, or in some embodiments “LCD television set of model X made by manufacturer Y and having size Z”. The nodes with further sub-categories represent abstract goods types, such as “television set”. Nodes may also be referred to as “categories”.

Each category type in the taxonomy, has one or more properties, also referred to as attributes. For example, “maximum speed” is an attribute of the “vehicle” category. Attributes are inherited. Therefore, the “car” category will have “maximum speed” attribute as well as “engine type” attribute. A set of possible values for an attribute is referred to as the attribute domain. The attribute domain may be a set of discrete values like “white”, “blue” and “green” values for a “color” attribute, a range of numeric values for a “weight” attribute which range between 1 and 2 pounds, free text, or other data structures. For numeric domains, an attribute may be defined using a measurement unit.

In some embodiments, the attributes themselves may have properties, such as “mandatory”: whether a value must be specified for the attribute, “multi-value”: if a user can indicate multiple values for an attribute, “visible”: whether the user can see the value of this attribute, or the like.

The goods taxonomy may change over time as goods are added or removed, and may be provided to the users so that the users can make their requests based upon the taxonomy. In addition, buyers or vendors can extend the taxonomy and attributes to allow an accurate description of the buyer's need, or the goods properties. These activities may be moderated by the system to prevent duplications or malicious use.

In some exemplary embodiments, steps 200-206 detailed below are preliminary steps that take place so that a deal can be defined and bids can be suggested to one or more buyers.

On optional step 200 a potential buyer registers with the system, and enters some details, such as e-mail, geographic location and possibly additional data. On optional step 201 the system receives and stores the buyer information. Step 200 and 201 are optional since a buyer can also start browsing without pre-registering with the system.

On step 202 a vendor registers with the system, and enters details to create a vendor profile, such as identification details, geographic location, supply areas, and type of goods that can be supplied.

On step 203 the system receives and stores the vendor profile.

On optional step 204 the vendor defines and stores one or more policies upon which it can later determine whether it can suggest bids to deals defined by the system. A policy is a set of rules, phrased for example in the form of an ordered pair comprising a set of conditions and a set of actions, wherein the conditions may refer to requested good or the deal details, and the actions perform computational steps operative to determine whether to submit a bid, and if so, to define the bid details.

In some exemplary embodiments vendor may define a separate policy for each supplied good or an organization-wide policy. The deal details, which the policy may take into account, may include any of: the available goods and inventory levels of each, the number of buyers interested in the good, the attractiveness of the good, the cash flow of the vendor, an expiration date of the deal after which no more orders will be processed, any combination of the above and/or any other factor. The bid terms may include, for example, the suggested goods, a price or a discount percentage, shipping area, shipping options, bid deadline, or the like. The policy may be implemented for example as an executable program, a script, or the like. The suggested bid may relate to one or more goods.

On step 205 the vendor stores the one or more policy, for example in a persistent database.

On step 206 the system obtains goods taxonomy detailing goods the system is operative to mediate for. Obtaining the taxonomy can be made, for example, by providing an entity such as a business manager with a tool for preparing such taxonomy, by automatically scanning catalogues, or in any other method. The system also obtains information for the products, including for example description, attributes, possible values for the attributes, reviews, or the like.

Steps 207 and further steps are on-going steps which take place when a buyer initiates action and the system is used. It will be appreciated that the way deals are defined by the system, or bids are generated by a vendor may be updated from time to time.

On step 207 a buyer may be looking to purchase an object or may be simply browsing and specifies goods.

The buyer can specify the desired good in a multiplicity of ways, including but not limited to pointing at a specific good category in the taxonomy, using keywords, and by example.

In some embodiments, the user selects a good belonging to a good category out of a representation of the taxonomy. This selection can be implemented as showing the user a graphic or textual arrangement of the taxonomy and letting the user choose the good or category he likes. In other cases the system may be sniffing the user's activities and suggesting a good in accordance with predefined rules. For example, if the user was searching for a “trip to China” more than twice during a 24 hour period, the system may actively suggest the user to check its offerings in this field, and when the user agrees, the taxonomy or the relevant part thereof is displayed. In other cases, the user surfs the internet as he regularly does, and when pointing out on an item he wishes to buy he can invoke the system to search what offerings there are for this item in the system.

In some exemplary embodiments, activity of the user in predetermined websites, such as retailer's websites may be monitored.

When using keywords, the buyer can enter a set consisting of one or more keywords. The set is processed in order to recognize the good category and attribute values of the goods specification. In this scenario each keyword may be processed in accordance with the following exemplary steps:
If the keyword contains decimal digits, it is assumed to be a value of a “Model” attribute, and the next keyword is processed. For example, in keywords “Refrigerator GE GTS18FBSWW” the keyword “GTS18FBSWW” is considered to be a model of the product.
The keyword is stemmed, i.e., reduced to its simplest form; such as singular instead of plural, or the like.
The resulting token is matched against taxonomy entries: category names, attribute names, or attribute values.

Each good category may be assigned a score that takes into account, for example, the number of keywords matched, the match type, i.e., full or partial, and whether the category name was matched or not. The resulting score is used to sort the possible goods.

In some embodiments, the value of the “model” is further used in web search, and the top entries may be processed as described above.

When searching for a good by example, the buyer may enter a Uniform Resource Locator (URL) of a page containing a similar good. The page is processed using any available method, such as but not limited to: Microformats, Microdata, Resource Description Framework in attributes (RDFa), HTML Metadata or others.

The search result is a good or category on the taxonomy, optionally associated with values assigned to at least some of its attributes.

If no good specification can be created, the buyer is prompted to redefine the search. If more than one good specification is created, the buyer is presented with a list sorted in some order, such as alphabetical, according to probability, or the like, and is prompted to select an entry.

Once a good specification is selected, the buyer may modify attribute values before a request is created.

When the good specification is finalized, a request is issued on behalf of the buyer to the system. The request comprises a product from the taxonomy and optionally values for some of the good's attributes, and in particular values of mandatory attributes. Each attribute may relate to the good, such as color, size, or the like, or to supplying the good such as the user's address, price, or the like.

A request may optionally comprise an expiration date, i.e., a latest date on which the buyer is interested in receiving suggestions or completing a purchase.

In some exemplary embodiments, a request may contain one or more hard constraints, i.e., attributes on which the user cannot compromise, such as power supply, maximal size, or the like, or one or more soft constraints, which are more like preferences. Each such attribute can be assigned one or more discrete values, or a value range.

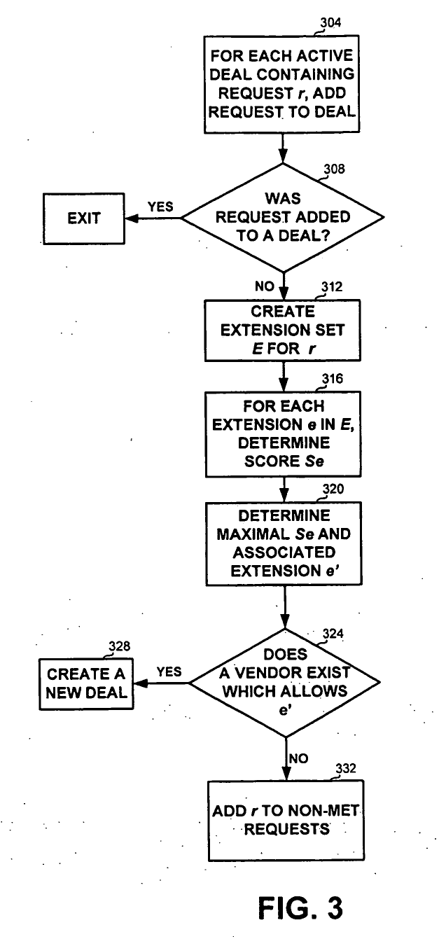

On step 208 the system receives the request, and on step 209 the system searches for similar requests made by other buyers (or the same buyer) and defines a deal that complies with the request. Complying with the request implies that at least one good which may be supplied in accordance with the deal meets the request and its attributes. The deal definition is detailed in association with FIG. 3 below. The deal optionally comprises a deadline which may be determined using the deadlines of the buyers whose request are included in the deal.

On step 212, the system notifies vendors about the deal as defined on step 208. The deal details are passed to one or more vendors who are known to the system as relevant, i.e., their profile indicates that they may be able to supply the good or goods associated with the deal. Additional conditions which may be part of the vendor profile may also be tested in order to verify that the vendor may be willing to receive such deal notifications. The vendors are determined in accordance with the vendor profiles as stored within the system on step 201.

On step 216, each of the one or more vendors is notified about the deal information.

On step 220 a vendor who received the deal generates a bid that complies with the deal requirements. The bid is devised based on the policies defined by the vendor on step 202, by considering the deal details or conditions, and receiving the bid details.

The bid generation can be performed automatically, manually, or semi-automatically. For example a bid can be generated automatically, wherein some details must be added or reviewed by a human.

The vendor defined policies may relate to a minimum or a maximum number of goods offered, a discount percentage, the goods type, price or discount, geographic location of the buyers, inventory level, or any other factor. The bid may include an expiration date after which the bid expires and no more orders can be accepted, wherein the expiration date is optionally earlier than the expiration date of the deal. The bid generation may be fully automatic or manual.

On step 224 the vendor provides the bid to the system and on step 228 the system receives the bid and may store it.

The vendor may withdraw the bid at any point in time prior to the bid expiration date. Preferably, if the bid was withdrawn, all buyers who placed orders receive full refund.

On step 232 the system notifies the relevant buyers, i.e., the buyers upon whose requests the deal has been defined or other buyers who may be interested, with the details of the one or more bids as provided by the vendors.

Notification steps 212 and 232 may be performed by posting a note on the buyer or vendor home page, sending a short message (SMS) or an e-mail, or the like, including automatically generated voice messages.

In an alternative embodiment the vendor may notify the buyers about the bid directly without involving the system. However, in such scenario the buyers may have to agree to have their details sent to vendors. In such embodiment, the deal definition as notified to the vendor has to include all buyer details.

On step 236 the buyer receives the relevant bids and may place an order.

At this stage, additional buyers may also join the deal and place an order with any of the bids.

In some embodiments, the buyers can communicate among them or communicate with the vendor, and try to refine the deal. For example, if one of the bids has a condition of minimum number of buyers, the buyers can influence each other to select that bid in order to enjoy its improved terms. The buyers or vendors may communicate through a system's forum application, a system's chat room, or the like.

On step 240, which may occur, for example, on or after the bid expiration date and time, the system receives the orders placed by the buyers and sends the details of the buyers and the good specification associated with each buyer to the vendor or vendors whose bids have been accepted. Alternatively, the orders may be sent directly to the vendor without the system being involved in the actual order and its supply.

On step 244 the vendor receives the orders and delivers the goods to the buyers, with or without the system being involved in the financial transactions.

Referring now to FIG. 3, showing a schematic flowchart of an exemplary embodiment of deal definition step 208 of FIG. 2.

In order to fully understand and appreciate the steps of the flowchart of FIG. 3; a number of concepts are explained below.

A good specification relates to a specific good category and comprises a set of value attributes.

An extension of a good specification psₘ is a specification psₙ, such that each value in psₘ is also in psₙ. For example, the “color” attribute of a refrigerator request having a “blue” value can be extended with “blue or white” values for the “color” attribute. An extension can also contain values for attributes not specified by the buyer, such as top-or-bottom freezer, price range, or any combination.

Likelihood between attribute value sets v_{m,i} and v_{n,i} is defined as the probability of finding a value belonging to m_{m,i} in v_{n,i}. For example, suppose thatv_{m,i} is the value set as specified by the user, which is a “blue” value for the “color” attribute”, and that v_{m,i} is the extension into “blue” and “white”. In this case, the likelihood is 50%, while if v_{m,i} comprises “blue”, “white” and “red” the likelihood would drop to 33.33%. Computation of the likelihood may be performed based on rules, configuration, historic requests and bids, or the like.

An attribute rank is a measure of significance of a good's attribute in the selection process. For example in some cases the volume of a refrigerator may be more important to the buyer than its color. The attribute ranks are preferably part of the goods taxonomy definitions, possibly based on user input. In some embodiments, the likelihood may be affected by the ranking of those attributes for which the user set values, which may mean that these attributes are important to him.

An attribute likelihood threshold is a likelihood value used to limit the extension generation process. The attribute likelihood thresholds may be determined upon historical data. When there are no past orders that use this attribute, a default value defined in the goods taxonomy may be used. For example, if a request comprises a “blue” value for the “color” attribute, and 80% of the sold refrigerators are white, extending the attribute value into “blue” and “white”, thus reducing the likelihood to 50% is enough and there is no point in extending the value with further colors.

Likelihood between goods' specifications is defined as the sum over all attributes, of the product of an attribute rank by the associated attribute value likelihood.

On step 304, the request received from a user is compared against all active deals, i.e., all deals that haven't expired yet. If any such deal is in compliance with such request, i.e. if the request attributes are contained in the deal attributes, the request is added to the deal.

On step 308 it is determined whether the request was added to at least one deal. If so, the process ends.

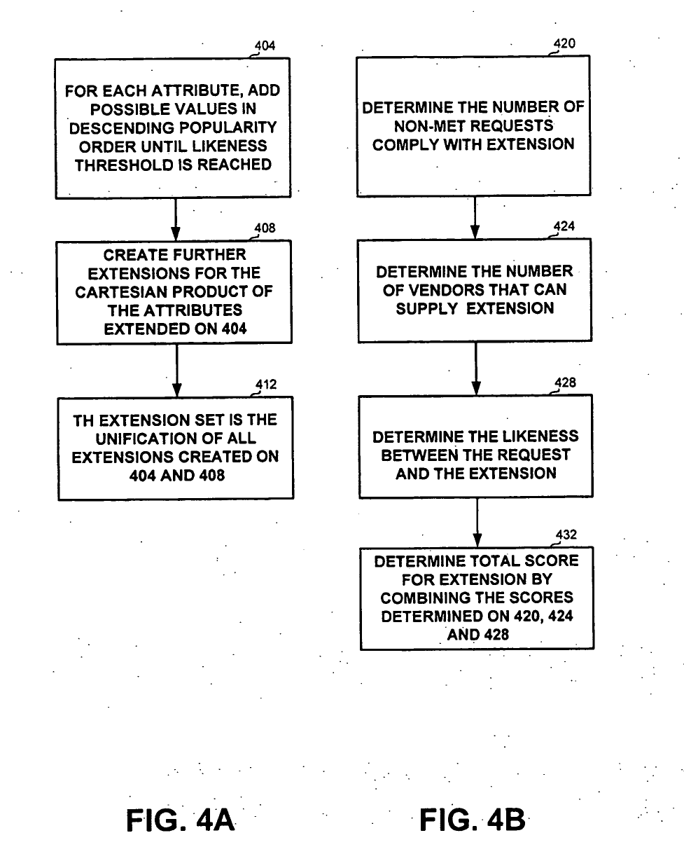

If no deal was found applicable for the request, then on step 312 one or more extensions are created for the request and optionally unified into an extension set. Each extension is less restrictive than the request, as more values are added to the value entered by the user for one or more attributes. Step 312 is further detailed in association with FIG. 4A below.

On step 316, a corresponding score is determined for each extension within the extension set. Step 316 is further detailed in association with FIG. 4B below.

On step 320, e′ is determined as the extension out of the extension set having the highest score.

On step 324, it is determined whether a vendor exists that can supply e′. If such vendor exists, on 328 a deal is created upon the extension e′.

The system determined whether a particular vendor may accept the deal in accordance with the vendor profile.

If no such vendor exists, then on 332 the request is added to all non-met requirements.

In some exemplary embodiments, a new deal may be created only if there are at least a minimal number of requests that are satisfied by the extension.

When the vendor is notified about the deal and determines whether and which bid to suggest, as detailed in association with step 220 of FIG. 2 above, it is required that the vendor can provide at least one good in compliance with the selected extension. For example, if the extension upon which the deal was defined relates to a blue or white refrigerator with a top or bottom freezer, the vendor has to be able to supply at least one of the four combinations.

Referring now to FIG. 4A, showing a flowchart of the main steps in an exemplary implementation of a method for creating an extension set for a request.

On step 404, each attribute aᵢ of a request r is extended with additional values from the domain, until the likelihood threshold is reached. In some exemplary embodiments the additional values may be added in a predetermined order, such as descending popularity order. The value set is limited both for computability reasons and for commercial reasons. The more different items a deal contains, the less likely vendors are to want or to be able to comply with it. For example, a “color” attribute may be extended from “blue” into “blue” and “white”, while a “top-bottom freezer” attribute may be extended from “bottom” into “bottom” and “top”.

For attributes having continuous values which may be in a particular range, the added values can be sub-ranges. For example, if the user indicated a price of 100$ or a range of 50-150$, an extension can relate to the range of 100-200$, since a user may be willing to pay more for a better good than he initially intended to buy.

On step 408, Cartesian products are created for the attribute values in the extensions created on step 404. In the example above, an extension will be created having “color” attribute values of “blue” and “white”, and “refrigerator type” attribute values of “top freezer”, “bottom freezer” and “side by side”,

Optionally, non-feasible combinations are erased. For example, if a bottom freezer is supplied only for white refrigerators, then the extension comprising a blue refrigerator and a bottom freezer is erased.

On step 412, the union of all extensions created on steps 404 and 408 is defined as the extension set for the request.

Attribute sets are extended in order to generate greater flexibility so that a multiplicity of buyers can receive a better suggestion from a vendor even if not all buyers are interested in the exact same good, but rather in similar goods. Extending may expose buyers to goods which may be different from those they initially intended to buy, but may be willing to consider if an attractive bid is suggested.

However, the attribute sets preferably are not to be extended unconditionally, since a very diverse group of goods means lots of species for the vendor to supply, which reduces the attractiveness of the aggregated sale.

It will be appreciated that by extending an attribute, a user may be offered some goods he does not want. For example, if the user wanted a blue refrigerator, and the attribute was extended into blue or white, the vendor's bid may refer only to white refrigerators, which the user may or may not want.

Referring now to FIG. 4B, showing a flowchart of the main steps in an exemplary implementation of a method for determining the score of an extension e.

On step 420 R(e) is determined, indicating how many of the non-met requests are in compliance with extension e.

On step 424, V(e) is determined, indicating the number of vendors that can supply the specific extension is determined, in accordance with the rules related to each vendor as provided by the vendor to the system.

On step 428, L(e) is determined, indicating the likelihood between the attribute set of the particular request and the extension is determined.

On step 432, the total score for the extension is determined as a combination of the partial scores determined on 420, 424 and 428 and possibly other information, such as historical information. For example, the score can be determined as α*R(e)+β·V(e)+γ*L(e)+K(e), wherein α,β and γ are constants, and K(e) takes into account additional parameters.

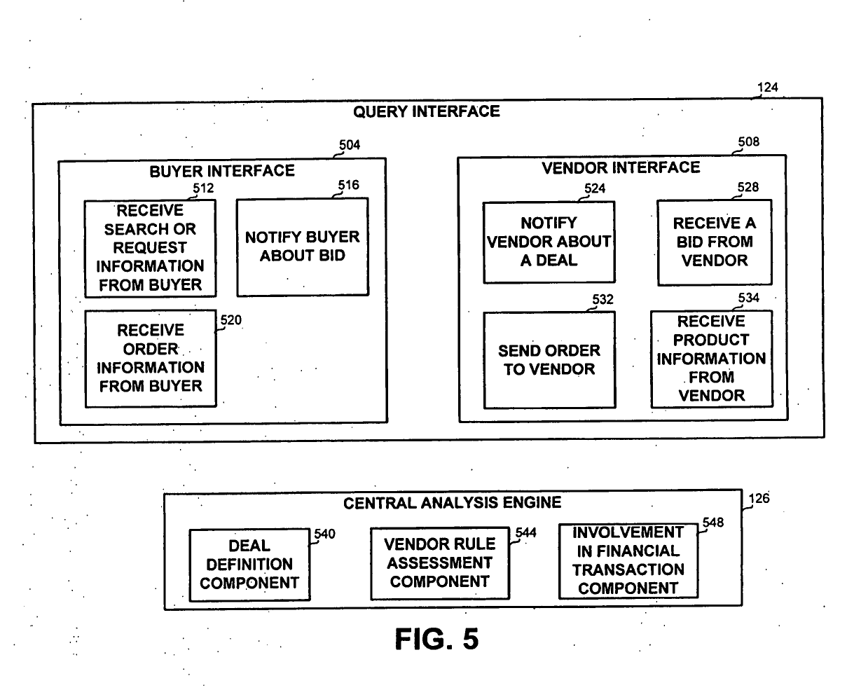

Referring now to FIG. 5, showing a simplified block diagram of the components of exemplary embodiment of query interface 124 and central analysis engine 126 of FIG. 1.

Query interface 124 which is executed by central platform 106 of FIG. 1 comprises a buyer interface 504 and a vendor interface 508, which send and receive information to and from the buyers' and vendors' computing platforms, respectively.

Buyer interface 504 comprises component 512 for receiving search and request information from a′ buyer. Search information generally refers to stages in which the buyer is searching and is not yet focused on any goods, while a request refers to a specific good optionally with values for one or more attributes. Buyer interface 504 further comprises component 516 for notifying a buyer about a bid as provided by a vendor, and component 520 for receiving order information from a buyer, once the buyer decided to actually purchase the good in accordance with the bid terms.

Vendor interface 508 comprises component 524 for notifying a vendor about a deal so that the vendor can generate a bid, component 528 for receiving a bid from a vendor, and component 532 for sending order information received from one or more buyers to the vendor.

Vendor interface 516 may further comprise optional component 534 for receiving product information from the vendor, so that the system can enable the buyer to refer to the relevant attributes, and for the system to define the deal. The product information can include the product description, product attributes, possible values, reviews, or the like.

Central analysis engine 126 comprises deal definition component 540 for defining a deal based on one or more user requests as detailed in association with FIG. 3 above, component 544 for assessing vendor rules and determining which vendors to approach with a defined deal, and optional component 548 assists in executing the financial transaction between buyers and vendors.

Component 540 for defining a deal optionally further comprises: an extension creation component for creating an extension for the request's attributes,: an optional extension set creation component for creating an extensions set of the created extensions, and an optional score determination component for associating a score with each extension, wherein the deal is created based on one of the extensions, such as the extension having the highest score.

Score determination component optionally comprises a non-met requests number determination component for determining the number of non-met requests which comply with a deal based upon the extension, a vendor number determination component for determining the number of vendors that can supply the deal based upon the extension to obtain a second factor; a likelihood determination component for determining a likelihood factor between the request and the extension to obtain a third factor; and a combination component for combining the number of non-met requests, the number of vendors, the likelihood factor and optionally additional factor such as historical deals or bids, which may or may not be associated with the extension.

It will be appreciated that the disclosed structure is general and shows only the components that relate to the disclosure. Additional components such as control flow components, communication components, database connectivity components, security and privacy components, or the like may be required and provided in accordance with the exact implementation used.

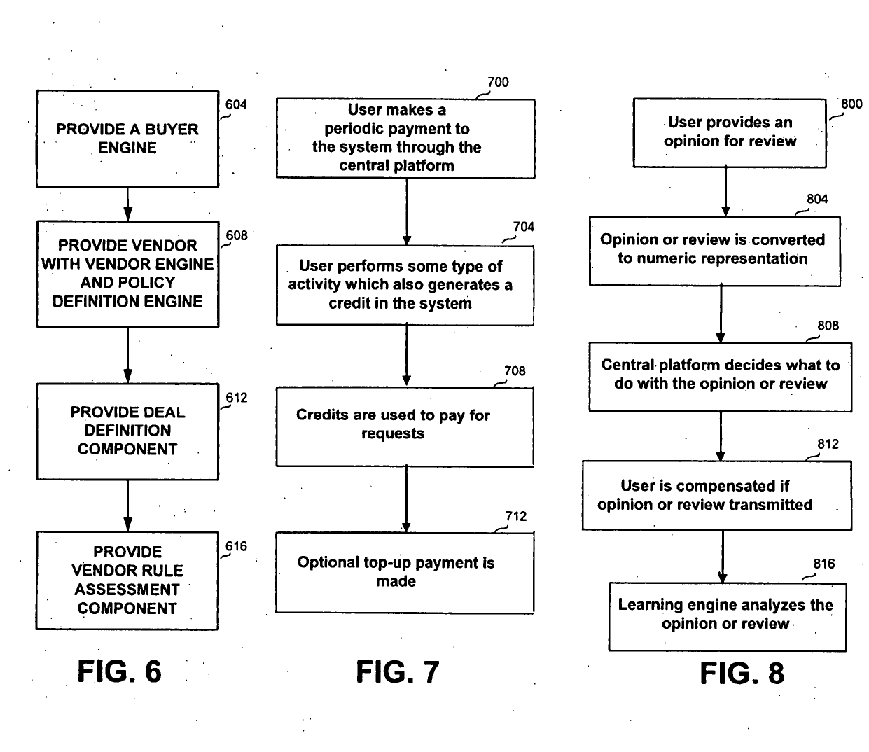

Referring now to FIG. 6, showing a schematic flowchart of the main steps required as preparation for providing a method for aggregated purchase, in accordance with the disclosure.

On step 604 a buyer engine which may be implemented as a computer program product is provided to a buyer, the buyer using a user computer. Buyer engine receives information from the user, optionally analyzes it, and communicates with the central platform for issuing a request, receiving a bid, placing an order, and optionally additional activities such as participating in discussions with other buyers or vendors. The buyer engine can also monitor other activities performed by the user, in order to suggest information, goods or services that may be of interest for the user. The buyer engine comprises a user interface component, and optionally monitoring, analysis or learning components.

It will be appreciated that the buyer engine can be installed or executed on the user computer as detailed in association with in FIG. 1A above. This embodiment provides the user greater control over the delivered information.

In other embodiments,: the buyer engine, optionally excluding a graphic user interface part, can be installed or executed by the central platform. In such embodiment, the user may have to sign in to the system or otherwise express his consent to being approached.

On step 608 a vendor engine and a policy definition engine are provided to a vendor using a vendor computer.

Vendor engine receives deals as created by the central platform, based on user requests, generates bids for relevant deals according to vendor's policies, and receives the details of users and user. Vendor engine may also be responsible for supporting the delivery of the orders.

Policy definition component enables a vendor to define policies, so that a bid can be created upon a deal received from the central platform, in accordance with the user policies. The bid can be generated on the vendor's computer, such as business computer 114 or on central platform 106.

On step 612 a deal definition component is provided, which receives a request from a user, optionally searches for other requests from other users, and generates a deal to which vendors can provide bids. The deal definition is further detailed in association with FIG. 3 above.

On step 616 a vendor rule assessment component is provided, which receives a deal and by accessing the vendor profiles or assessing rules associated with each vendor, determines which vendors may be interested and are to be approached so that they can offer bids for the deal, and supply the orders.

It will be appreciated that the order of steps detailed above is not obliging, and in some embodiments different order can be used, while in further embodiments, the steps can be carried out in any order.

It will be appreciated that variants of the disclosed method can be used for a multiplicity of other applications.

In one example, the method can be used in reverse order, in which a company such as a recycler wishes to purchase recyclables such as used batteries. In such case, multiple users such as private people may be aggregated based on geographical proximity and types of available recyclables, and supply the recyclables to the recycler that offers the best terms, operates under the highest environmental standards, or the like.

In another example, a social network member expressing interest in a particular subject, such as French films may be invited to a group of related although broader interests, such as European films.

Referring now to FIG. 7, showing a flowchart of an exemplary, illustrative method for an internal economy for the system according to at least some embodiments of the present disclosure.

On step 700, the user makes a periodic payment to the system through the central platform, for example through a periodic subscription with periodic payments.

On 704, the user, such as, a buyer performs some type of activity which also generates credit in the system, for example by providing information, placing a request, making an order, providing a review about a good, a product, or the like. Such information could also optionally be related to rating a vendor or another user in terms of customer satisfaction, providing expert assistance in a particular subject and the like.

On step 708, the user requests information related to goods or services through the user interface, as described above. The credits related to the user may then used to pay for these activities.

On step 712, if necessary, the user makes an additional “top up” payment, preferably through the user interface, for example by credit card.

It will be appreciated that FIG. 7 which relates to periodic payments, is merely an exemplary business model, and other models can be used as well, for example commission paid by either party.

Referring now to FIG. 8, showing the main steps in a method for detecting, analyzing and preserving user knowledge or user intellectual property (IP). Users, which in this case are considered as individuals but may optionally be companies or any type of organization or group of individuals, typically have a great deal of information which may be worthwhile to others. Similarly, such user knowledge or information also reflects upon the interests and desires of the user, and as such could also optionally be used by the previously described learning engine to learn more about user preferences. The method described in association with FIG. 8 assumed to operate with the above described system for the user centric internet.

On step 800, the user provides an opinion or review, whether as the result of a direct question or request, or through a voluntary provision by the user, preferably through the user interface. The review or opinion could be about anything of which the user has knowledge, including but not limited to the review of any good, vendor, or service provider such as a doctor, a lawyer, an accountant or other professional; any type of entertainment business or service such as a restaurant, a show, movie or other entertainment; any type of transportation; any type of location; any type of activity; and so forth. The user preferably also indicates the basis of the user's knowledge, and also whether the user has any professional education and/or experience and/or knowledge in this area.

On step 804, the opinion or review may be converted to some type of numeric representation, optionally as a string of numbers, which is preferably weighted according to the user's professional education and/or experience and/or knowledge in this area.

On step 808, the central platform preferably decides what to do with the opinion or review—for example, to send it one or more other users or to store it at the central platform for later analysis.

On step 812, if the central platform decides to send the opinion to one or more other users, then the user who generated the opinion or review is preferably compensated, for example with the above described credits. Optionally, the user who generated the opinion or review is able to restrict its distribution and/or the extent to which the generating user is identified.

On step 816, the learning engine, whether located at the central platform or at the user computer, analyzes the opinion or review in order to learn more about the user that provided the opinion, for example with regard to interests and so forth. This information may optionally be maintained only at the user computer or may optionally be propagated to the central platform as previously described.

The disclosed method and apparatus provide for aggregated purchasing in which the process is initiated by a buyer and in accordance with the buyer's needs, thus providing a user-centric method and apparatus for aggregated purchasing.

The method: and apparatus receive a good, and relevant attributes from a user wishing to buy the good. The system aggregates the user request with other user requests to define a deal which may be beneficial to a vendor wishing to sale a large quantity of goods.

For that end the system may extend the attribute set provided by the user to include additional goods and comply with more requests. The system examines which vendors may be able to supply the deal, and approaches the vendors.

Each vendor determines whether he is interested in bidding for the deal and if so generates a bid and returns it to the system. The system suggests the bid to the buyers, and each interested buyer can place an order. When the deadline of a bid expires, all placed orders are served, financial transaction is performed, and the goods are delivered.

The disclosed method thus transforms a user request which may include a good with or without additional details into a deal which may include other goods or different requests for the same good. The deal in turn is transformed into a bid by a vendor for providing the actual goods, which in turn is transformed into one or more purchases of the goods.

While the invention has been described with respect to a limited number of embodiments, it will be appreciated that many variations, modifications and other applications of the invention may be made.

The corresponding structures, materials, acts; and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a computing platform, comprising:
receiving from a user a request to purchase a good;
defining a deal, the deal complying with the request and with at least one second request stored on a storage device associated with the computing platform;
notifying a vendor about the deal; and
receiving a bid from the vendor to provide the good, the bid based on the deal.

2. The method of claim 1 further comprising notifying the user about the bid.

3. The method of claim 2 further comprising receiving from the user an order based on the bid.

4. The method of claim 1 wherein the request comprises identification of a good type and at least one attribute, the at least one attribute relates to at least one property selected from the group consisting of: the good and supplying the good,
and wherein said defining the deal comprises creating an extension of the request, the extension being less restrictive than the request, and defining the deal is based on the extension.

5. The method of claim 4 wherein said creating the extension comprises:
creating an extension set comprising at least one extension to the request, wherein each of the at least one extension is less restrictive than the request;
determining a score for each extension of the extension set; and
based on the score, selecting the extension out of the extension set.

6. The method of claim 5 wherein said creating the extension set comprises:
for a portion of the at least one attribute, determining a less restrictive one or more attribute, the less restrictive one or more attributes are within a likelihood measurement of the portion of the at least one attribute.

7. The method of claim 5 wherein said determining the score for each extension comprises determining a number of non-met requests that are in compliance with the extension to obtain a requests number.

8. The method of claim 5 wherein said determining the score for each extension comprises determining a number of vendors that can supply the extension to obtain a vendor number.

9. The method of claim 5 wherein said determining the score for each extension comprises determining a likelihood factor between the request and the extension.

10. The method of claim 5 wherein said determining the score for the extension comprises:
determining a request number as a number of non-met requests that are in compliance with the extension to obtain;
determining a vendor number as a number of vendors that can supply the extension to obtain;
determining a likelihood factor between the request and the extension; and
combining the requests number, the vendor number, the likelihood factor and information related to historical requests.

11. An apparatus adapted to be execute by at least one computing platform, comprising:
a query interface for interfacing with a user computer, and with a business computer, the query interface comprising:
a buyer interface comprising a first receiving component for receiving a request from a buyer; and
a vendor interface comprising a notification component for notifying a vendor about a deal;
a central analysis engine comprising:
a deal definition component for defining the deal, the deal complying with the request and with at least one second request stored on a storage device associated with the at least one computing platform;
a vendor rule assessment engine for determining a vendor to be notified with the deal; and
a database for storing the request and the deal.

12. The apparatus of claim 11 wherein the buyer interface further comprises a component for notifying the buyer about a bid suggested by the vendor.

13. The apparatus of claim 12
wherein the buyer interface further comprises a component for receiving an order from the buyer, and
wherein the vendor interface further comprises a component for notifying the vendor about the order.

14. The apparatus of claim 11 wherein the request comprises identification of a good category, and at least one attribute, the at least one attribute relates to at least one property selected from the group consisting of: the good and supplying the good, and wherein defining the deal definition component comprises an extension creation component for creating at least one extension of the request, the at least one extension being less restrictive than the request.

15. The apparatus of claim 14 further comprising:
an extension set creation component for creating an extension set comprising the at least one extension; and
a score determination component for determining a score for each extension of the extension set.

16. The apparatus of claim 15 wherein creating each extension of the extension set comprises: for a portion of the at least one attribute, determining a less restrictive one or more attribute, the less restrictive one or more attributes are within a likelihood measurement of the portion of the at least one attribute.

17. The apparatus of claim 15 wherein the score determination component comprises:
a non-met requests determination component for determining a number of non-met requests which comply with the extension;
a vendor number determination component for determining a number of vendors that can supply the extension to obtain a second factor;
a likelihood determination component for determining a likelihood factor between the request and the extension to obtain a third factor; and
a combination component for combining the of non-met requests, the number of vendors and the likelihood factor.

18. The apparatus of claim 11 wherein the query interface further comprises a ‘component for receiving product information from vendors, the information necessary for policy processing.

19. A method for providing a aggregated purchasing apparatus comprising:
providing a buyer engine;
providing a vendor engine and a policy definition engine; and
providing a deal definition component for defining a deal based on requests,
wherein at least one of the buyer engine, vendor engine, policy definition engine and deal definition component is embedded on at least one computer storage medium.

20. A computer program product comprising:
a non-transitory computer readable medium;
a first program instruction for receiving from a user a request to purchase a good;
a second program instruction for defining a deal, the deal complying with the request and with at least one second request stored on a storage device;
a third program instruction for notifying a vendor about the deal; and
a fourth program instruction for receiving a bid from the vendor to provide the good, the bid based on the deal,
wherein said first, second, third and fourth program instructions are stored on said non-transitory computer readable medium.
